(19) United States
(12) Patent Application Publication
(10) Pub. No.: US 2011/0259216 A1
(43) Pub. Date: Oct. 27, 2011

(54) IMAGING SYSTEM AND METHOD FOR ALIGNMENT

(76) Inventors: Martyn Buttle, Dorset (GB); Martin Symons, Dorset (GB)

(21) Appl. No.: 12/933,296

(22) PCT Filed: Mar. 17, 2009
(86) PCT No.: PCT/GB2009/000722

§ 371 Date: May 6, 2011

(30) Foreign Application Priority Data
Mar. 17, 2008 (GB) 0804941.3

(51) Int. Cl. B41M 1/12; H04N 5/33; H04N 7/18

(52) U.S. Cl. 101/126; 348/95; 101/129

(57) ABSTRACT

An imaging system for and a method of imaging at least one workpiece alignment feature on an upper surface of a supported workpiece, the system comprising: a workpiece support which includes a support surface for supporting a workpiece; and at least one imaging unit which is disposed below the support surface of the workpiece support for imaging at least one workpiece alignment feature on the upper surface of the workpiece, wherein the at least one imaging unit comprises an infra-red illuminator which is operative to illuminate a region of a lower surface of the workpiece and a detector which is operative to capture an image of the region of the workpiece which includes at least one workpiece alignment feature on the upper surface of the workpiece.

The present invention relates to an imaging system for and a method of imaging a workpiece, in particular a printed circuit board, in order to provide for alignment of the workpiece to a printing screen, often alternatively referred to as a printing stencil.

Screen printing machines are extensively used for depositing print media, such as solder pastes and adhesives, on printed circuit boards in the manufacture of electronic circuit boards.

In printing on printed circuit boards, it is necessary to align the printing screen to the printed circuit board in order to ensure that deposits of print medium are printed on the printed circuit board at the required positions.

Currently, in aligning the printing screen to a printed circuit board, one or more video cameras are introduced between the printed circuit board and the printing screen to image one or more alignment features on the printed circuit board and the printing screen, and the acquired images are processed using image processing software to determine the misalignment and required positional correction of the printed circuit board and the printing screen.

In order to achieve the required accuracy, alignment features are imaged at two or more widely-spaced positions on the printed circuit board and the printing screen.

In requiring one or more video cameras to be introduced between the printed circuit board and the printing screen, there is a time penalty in introducing the one or more video cameras and withdrawing the same after acquiring the images, and also with closing the gap between the printed circuit board and the printing screen, which gap is necessary to allow for the introduction of the one or more video cameras.

Further, where a single video camera is used, there is a time penalty associated with moving the video camera between each of the imaging positions, in acquiring each of the images.

These time factors add directly to the cycle time of the screen printing machine, and therefore reduce the throughput of the machine.

It is an aim of the present invention to provide an imaging system for and a method of imaging workpieces which avoids the need to introduce an imaging unit, such as a video camera, between the workpiece and a printing screen.

In one aspect the present invention provides an imaging system for imaging at least one workpiece alignment feature on an upper surface of a supported workpiece, the system comprising: a workpiece support which includes a support surface for supporting a workpiece; and at least one imaging unit which is disposed below the support surface of the workpiece support for imaging at least one workpiece alignment feature on the upper surface of the workpiece, wherein the at least one imaging unit comprises an infra-red illuminator which is operative to illuminate a region of a lower surface of the workpiece and a detector which is operative to capture an image of the region of the workpiece which includes at least one workpiece alignment feature on the upper surface of the workpiece.

In one embodiment the infra-red illuminator is a near infra-red illuminator.

In one embodiment the infra-red illuminator provides illumination at a wavelength in the range of about 760 nm to about 1000 nm.

In one embodiment the infra-red illuminator provides illumination at a wavelength of about 880 nm.

In one embodiment the system comprises: first and second imaging units for imaging first and second workpiece alignment features on the upper surface of the workpiece.

In one embodiment the imaging units comprise camera units and the detector comprises a camera.

In one embodiment the illuminator of each imaging unit is operative to illuminate both a region of a lower surface of the workpiece and a region of a lower surface of a printing screen which is disposed above the workpiece support, and the detector of each imaging unit is operative to capture both an image of the region of the workpiece which includes at least one workpiece alignment feature on the upper surface of the workpiece and an image of the region of the printing screen which includes at least one screen alignment feature.

In another embodiment the illuminator of each imaging unit is operative to illuminate a region of a lower surface of a printing screen which is disposed above the workpiece support when no workpiece is supported on the workpiece support and illuminate a region of a lower surface of the workpiece when supported on the workpiece support, and the detector of each imaging unit is operative to capture an image of the region of the printing screen which includes at least one screen alignment feature when no workpiece is supported on the workpiece support and capture an image of the region of the workpiece which includes at least one workpiece alignment feature on the upper surface of the workpiece when supported on the workpiece support.

In a further embodiment the system further comprises: at least one further imaging unit for imaging at least one screen alignment feature on a printing screen which is disposed above the workpiece support, wherein the at least one further imaging unit comprises an illuminator which is operative to illuminate a region of a lower surface of the printing screen and a detector which is operative to capture an image of the region of the printing screen which includes at least one screen alignment feature.

In one embodiment the system comprises: first and second further imaging units for imaging first and second screen alignment features on the printing screen.

In another aspect the present invention provides a screen printing machine, comprising: the above-described imaging system.

In a further aspect the present invention provides a screen printing machine, comprising: the above-described imaging system; an image processor for determining a required positional correction of the workpiece and the printing screen from the imaged alignment features; and a positioner for performing the required positional correction of the workpiece and the printing screen.

In a still further aspect the present invention provides a method of imaging at least one workpiece alignment feature on an upper surface of a supported workpiece, the method comprising the steps of: supporting a workpiece on a support surface of a workpiece support; and imaging at least one workpiece alignment feature on the upper surface of the workpiece from below the support surface of the workpiece support, wherein the imaging step comprises the steps of: illuminating a region of a lower surface of the workpiece with infra-red illumination; and capturing an image of the region of the workpiece which includes at least one workpiece alignment feature on the upper surface of the workpiece.

In one embodiment the infra-red illumination is near infra-red illumination.

In one embodiment the infra-red illumination has a wavelength in the range of about 760 nm to about 1000 nm.

In one embodiment the infra-red illumination has a wavelength of about 880 nm.

In one embodiment, in the imaging step, first and second workpiece alignment features are imaged on the upper surface of the workpiece, and the imaging step comprises the steps of: illuminating first and second regions of a lower surface of the workpiece with infra-red illumination; and capturing first and second images of the regions of the workpiece which include respective ones of first and second workpiece alignment features on the upper surface of the workpiece.

In another embodiment a printing screen is disposed above the workpiece support and at least one screen alignment feature on the printing screen is further imaged in the imaging step, and the imaging step comprises the steps of: illuminating both a region of a lower surface of the workpiece and a region of a lower surface of the printing screen with an illuminator, wherein the lower surface of the workpiece is illuminated with infra-red illumination; and capturing both an image of the region of the workpiece which includes at least one workpiece alignment feature on the upper surface of the workpiece and an image of the region of the printing screen which includes at least one screen alignment feature with a detector.

In a further embodiment a printing screen is disposed above the workpiece support and at least one screen alignment feature on the printing screen is further imaged in the imaging step, and the imaging step comprises the steps of: illuminating a region of a lower surface of the printing screen when no workpiece is supported on the workpiece support; capturing an image of the region of the printing screen which includes at least one screen alignment feature; supporting a workpiece on the workpiece support; illuminating a region of a lower surface of the workpiece with infra-red illumination; and capturing an image of the region of the workpiece which includes at least one workpiece alignment feature.

In a yet further embodiment a printing screen is disposed above the workpiece support and, in the imaging step, first and second workpiece alignment features are imaged on the upper surface of the workpiece and first and second screen alignment features are imaged on the printing screen, and the imaging step comprises the steps of: illuminating first regions of a lower surface of the workpiece and a lower surface of the printing screen with a first illuminator, and second regions of the lower surface of the workpiece and the lower surface of the printing screen with a second illuminator, wherein the regions of the lower surface of the workpiece are illuminated with infra-red illumination; and capturing first images of the first region of the workpiece which includes at least one workpiece alignment feature on the upper surface of the workpiece and the first region of the printing screen which includes at least one screen alignment feature using a first detector, and second images of the second region of the workpiece which includes at least one workpiece alignment feature on the upper surface of the workpiece and the second region of the printing screen which includes at least one screen alignment feature using a second detector.

In a still yet further embodiment a printing screen is disposed above the workpiece support and, in the imaging step, first and second workpiece alignment features are imaged on the upper surface of the workpiece and first and second screen alignment features are imaged on a printing screen, and the imaging step comprises the steps of: illuminating first and second regions of a lower surface of the workpiece with respective ones of first and second illuminators, which are infra-red illuminators; illuminating first and second regions of a lower surface of the printing screen with respective ones of third and fourth illuminators; capturing first and second images of the first and second regions of the workpiece which include respective ones of first and second workpiece alignment features on the upper surface of the workpiece using respective ones of first and second detectors; and capturing first and second images of the first and second regions of the printing screen which include respective ones of first and second screen alignment features using respective ones of third and fourth detectors.

In a yet further aspect the present invention provides a method of screen printing on workpieces, the method comprising the steps of: imaging at least one workpiece alignment feature on an upper surface of a supported workpiece using the above-described imaging method.

In a still yet further aspect the present invention provides a method of screen printing on workpieces, the method comprising the steps of: imaging at least one workpiece alignment feature on an upper surface of a supported workpiece and at least one screen alignment feature on the printing screen using the above-described imaging method; determining a required positional correction of the workpiece and the printing screen from the imaged alignment features; and performing the required positional correction of the workpiece and the printing screen.

A preferred embodiment of the present invention will now be described hereinbelow by way of example only with reference to the accompanying drawings, in which:

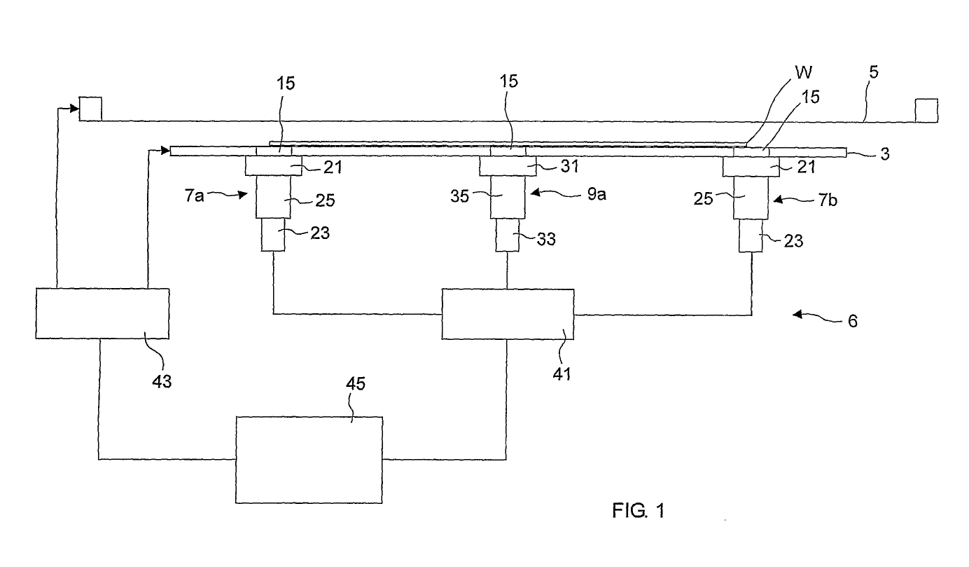

FIG. 1 illustrates a side elevational view of a screen printing machine incorporating an imaging system in accordance with a preferred embodiment of the present invention;

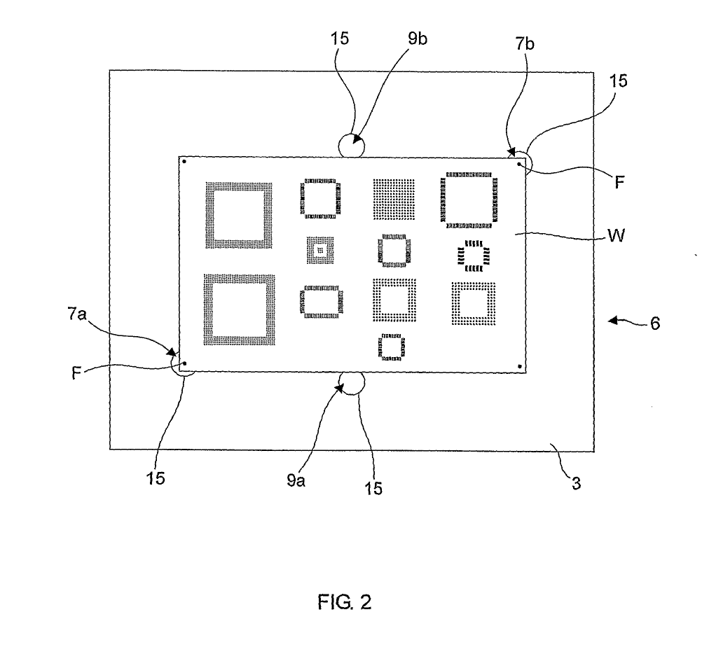

FIG. 2 illustrates a plan view of the imaging system of FIG. 1;

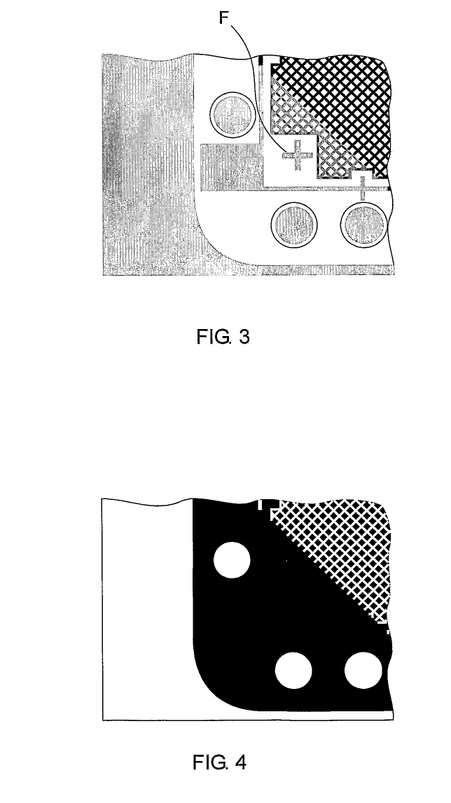

FIG. 3 illustrates an image acquired from the lower surface of a workpiece using the imaging system of FIG. 1; and

FIG. 4 illustrates a counterpart image to FIG. 3, but where acquired using visible light as the illumination source.

The screen printing machine comprises a workpiece support 3, in this embodiment a flat plate, for supporting a workpiece W, in this embodiment a printed circuit board, a printing screen 5 which is disposed above the workpiece support 3 for printing a pattern of deposits of a print medium, such as a solder paste or adhesive, onto the supported workpiece W, and an imaging system 6 which comprises a plurality of imaging units 7, 9, in this embodiment camera units, for imaging alignment features F, in this embodiment registration marks, often referred to as fiducials, on the upper surface of the workpiece W and the lower surface of the printing screen 5.

In this embodiment the workpiece support 3 includes a plurality of windows 15 through which respective ones of the imaging units 7, 9 of the imaging system 6 acquire images from the workpiece W and the printing screen 5.

In this embodiment the imaging system 6 comprises first and second workpiece imaging units 7a, 7b for imaging alignment features F on the upper surface of the workpiece W.

In this embodiment the first and second workpiece imaging units 7a, 7b are located at spaced positions so as to acquire images from alignment features F at spaced locations on the upper surface of the workpiece W, here at diagonally-opposite corners of the workpiece W.

Each workpiece imaging unit 7a, 7b comprises an illuminator 21, in this embodiment an infra-red (IR) light source, for illuminating a respective region of the lower surface of the workpiece W, the upper surface of which includes an alignment feature F, a camera 23 and associated optics 25 for acquiring an image of the illuminated alignment feature F.

In this embodiment the IR light source is a near infra-red (NIR) light source, which provides infra-red illumination at a wavelength of about 880 nm. In preferred embodiments the infra-red illumination has a wavelength in the range of about 760 nm to about 1000 nm.

The present inventors have recognized that it is possible to image an alignment feature F on an upper surface of a workpiece W from the lower surface of the workpiece W by using infra-red illumination. In a preferred embodiment the workpiece W is configured so as to include no artifacts on the lower surface thereof or within the body thereof which could mask the alignment features F to be imaged on the upper surface of the workpiece W.

FIG. 3 illustrates an image of the workpiece W as acquired from the lower surface of the workpiece W using one of the workpiece imaging units 7a, 7b, which clearly shows the alignment feature F on the upper surface of the workpiece W.

For comparison, FIG. 4 illustrates the corresponding image of the workpiece W, where illuminated using visible light.

In this embodiment the imaging system 6 comprises first and second screen imaging units 9a, 9b for imaging alignment features F on the lower surface of the printing screen 5.

In this embodiment the first and second screen imaging units 9a, 9b are located at spaced positions so as to acquire images from alignment features F at spaced locations on the lower surface of the printing screen 5, here at opposite edges of the printing screen 5.

Each screen imaging unit 9a, 9b comprises an illuminator 31, in this embodiment a visible light source, for illuminating a respective region of the lower surface of the printing screen 5 which includes an alignment feature F, a camera 33 and associated optics 35 for acquiring an image of the illuminated alignment feature F.

With this configuration, alignment features F on the upper surface of the workpiece W and the lower surface of the printing screen 5 can be imaged without requiring the introduction of any components between the workpiece W and the printing screen 5. In this way, the spacing between the workpiece W and the printing screen 5 can be kept to a minimum, in this embodiment in the range of from about 2 mm to about 10 mm, typically about 5 mm, which reduces the time required to move the workpiece W and the printing screen 5 into the operative, printing configuration.

Following the acquisition of the images of the alignment features F on the workpiece W and the printing screen 5, the images are operated upon using an image processor 41, which utilizes known vision algorithms to calculate the required positional correction of the workpiece W and the printing screen 5, and this positional correction is performed using a positioner 43, under the control of a controller 45, typically a PC-controller.

In an alternative embodiment the imaging system 6 could comprise first and second imaging units 7a, 7b, which are operative to acquire images both of respective alignment features F on the upper surface of the workpiece W and the lower surface of the printing screen 5.

In one embodiment the imaging system 6 is configured to acquire images from the underside of the printing screen 5 prior to loading of a workpiece W, and subsequently images from a workpiece W following loading of the workpiece W. In this way, the alignment features F on the workpiece W and the printing screen 5 are acquired using a reduced number of imaging units 7a, 7b.

In another embodiment, where the alignment features F on the workpiece W and the printing screen 5 are sufficiently closely located, each imaging unit 7a, 7b simultaneously images alignment features on both the workpiece W and the printing screen 5. Again, this configuration allows for the use of a reduced number of imaging units 7a, 7b. This embodiment also advantageously only requires a single imaging step, as compared to separate steps for imaging the workpiece W and the printing screen 5.

Finally, it will be understood that the present invention has been described in its preferred embodiment and can be modified in many different ways without departing from the scope of the invention as defined by the appended claims.

For example, in the described embodiment the alignment features F are registration marks on the workpiece W and the printing screen 5, but could be other physical features of the workpiece W or the printing screen 5, such as edges, which are identifiable in determining position.

1. An imaging system for imaging at least one workpiece alignment feature on an upper surface of a supported workpiece, the system comprising:
a workpiece support which includes a support surface for supporting a workpiece; and
at least one imaging unit which is disposed below the support surface of the workpiece support for imaging at least one workpiece alignment feature on the upper surface of the workpiece, wherein the at least one imaging unit comprises an infra-red illuminator which is operative to illuminate a region of a lower surface of the workpiece and a detector which is operative to capture an image of the region of the workpiece which includes at least one workpiece alignment feature on the upper surface of the workpiece.

2. The system of claim 1, wherein the infra-red illuminator is a near infra-red illuminator.

3. The system of claim 2, wherein the infra-red illuminator provides illumination at a wavelength in the range of about 760 nm to about 1000 nm.

4. The system of claim 3, wherein the infra-red illuminator provides illumination at a wavelength of about 880 nm.

5. The system of claim 1, comprising:
first and second imaging units for imaging first and second workpiece alignment features on the upper surface of the workpiece.

6. The system of claim 1, wherein the imaging units comprise camera units and the detector comprises a camera.

7. The system of claim 1, wherein the illuminator of each imaging unit is operative to illuminate both a region of a lower surface of the workpiece and a region of a lower surface of a printing screen which is disposed above the workpiece support, and the detector of each imaging unit is operative to capture both an image of the region of the workpiece which includes at least one workpiece alignment feature on the upper surface of the workpiece and an image of the region of the printing screen which includes at least one screen alignment feature.

8. The system of claim 1, wherein the illuminator of each imaging unit is operative to illuminate a region of a lower surface of a printing screen which is disposed above the workpiece support when no workpiece is supported on the workpiece support and illuminate a region of a lower surface of the workpiece when supported on the workpiece support, and the detector of each imaging unit is operative to capture an image of the region of the printing screen which includes at least one screen alignment feature when no workpiece is supported on the workpiece support and capture an image of the region of the workpiece which includes at least one workpiece alignment feature on the upper surface of the workpiece when supported on the workpiece support.

9. The system of claim 1, further comprising:
at least one further imaging unit for imaging at least one screen alignment feature on a printing screen which is disposed above the workpiece support, wherein the at least one further imaging unit comprises an illuminator which is operative to illuminate a region of a lower surface of the printing screen and a detector which is operative to capture an image of the region of the printing screen which includes at least one screen alignment feature.

10. The system of claim 9, further comprising:
first and second further imaging units for imaging first and second screen alignment features on the printing screen.

11. A screen printing machine, comprising:
the imaging system of claim 1.

12. A screen printing machine, comprising:
the imaging system of claim 7;
an image processor for determining a required positional correction of the workpiece and the printing screen from the imaged alignment features; and
a positioner for performing the required positional correction of the workpiece and the printing screen.

13. A method of imaging at least one workpiece alignment feature on an upper surface of a supported workpiece, the method comprising the steps of:
supporting a workpiece on a support surface of a workpiece support; and
imaging at least one workpiece alignment feature on the upper surface of the workpiece from below the support surface of the workpiece support, wherein the imaging step comprises the steps of:
illuminating a region of a lower surface of the workpiece with infra-red illumination; and
capturing an image of the region of the workpiece which includes at least one workpiece alignment feature on the upper surface of the workpiece.

14. The method of claim 13, wherein the infra-red illumination is near infra-red illumination.

15. The method of claim 14, wherein the infra-red illumination has a wavelength in the range of about 760 nm to about 1000 nm.

16. The method of claim 15, wherein the infra-red illumination has a wavelength of about 880 nm.

17. The method of claim 13, wherein, in the imaging step, first and second workpiece alignment features are imaged on the upper surface of the workpiece, and the imaging step comprises the steps of:
illuminating first and second regions of a lower surface of the workpiece with infra-red illumination; and
capturing first and second images of the regions of the workpiece which include respective ones of first and second workpiece alignment features on the upper surface of the workpiece.

18. The method of claim 13, wherein a printing screen is disposed above the workpiece support and at least one screen alignment feature on the printing screen is further imaged in the imaging step, and the imaging step comprises the steps of:
illuminating both a region of a lower surface of the workpiece and a region of a lower surface of the printing screen with an illuminator, wherein the lower surface of the workpiece is illuminated with infra-red illumination; and
capturing both an image of the region of the workpiece which includes at least one workpiece alignment feature on the upper surface of the workpiece and an image of the region of the printing screen which includes at least one screen alignment feature with a detector.

19. The method of claim 13, wherein a printing screen is disposed above the workpiece support and at least one screen alignment feature on the printing screen is further imaged in the imaging step, and the imaging step comprises the steps of:
illuminating a region of a lower surface of the printing screen when no workpiece is supported on the workpiece support;
capturing an image of the region of the printing screen which includes at least one screen alignment feature;
supporting a workpiece on the workpiece support;
illuminating a region of a lower surface of the workpiece with infra-red illumination; and
capturing an image of the region of the workpiece which includes at least one workpiece alignment feature.

20. The method of claim 13, wherein a printing screen is disposed above the workpiece support and, in the imaging step, first and second workpiece alignment features are imaged on the upper surface of the workpiece and first and second screen alignment features are imaged on the printing screen, and the imaging step comprises the steps of:
illuminating first regions of a lower surface of the workpiece and a lower surface of the printing screen with a first illuminator, and second regions of the lower surface of the workpiece and the lower surface of the printing screen with a second illuminator, wherein the regions of the lower surface of the workpiece are illuminated with infra-red illumination; and
capturing first images of the first region of the workpiece which includes a first workpiece alignment feature on the upper surface of the workpiece and the first region of the printing screen which includes a first screen alignment feature using a first detector, and second images of the second region of the workpiece which includes a second workpiece alignment feature on the upper surface of the workpiece and the second region of the printing screen which includes a second screen alignment feature using a second detector.

21. The method of claim 13, wherein a printing screen is disposed above the workpiece support and, in the imaging step, first and second workpiece alignment features are imaged on the upper surface of the workpiece and first and second screen alignment features are imaged on a printing screen, and the imaging step comprises the steps of:
illuminating first and second regions of a lower surface of the workpiece with respective ones of first and second illuminators, which are infra-red illuminators;
illuminating first and second regions of a lower surface of the printing screen with respective ones of third and fourth illuminators;
capturing first and second images of the first and second regions of the workpiece which include respective ones of first and second workpiece alignment features on the upper surface of the workpiece using respective ones of first and second detectors; and
capturing first and second images of the first and second regions of the printing screen which include respective ones of first and second screen alignment features using respective ones of third and fourth detectors.

22. A method of screen printing on workpieces, the method comprising the steps of:
imaging at least one workpiece alignment feature on an upper surface of a supported workpiece using the imaging method of claim 13.

23. A method of screen printing on workpieces, the method comprising the steps of:
imaging at least one workpiece alignment feature on an upper surface of a supported workpiece and at least one screen alignment feature on the printing screen using the imaging method of claim 18;
determining a required positional correction of the workpiece and the printing screen from the imaged alignment features; and
performing the required positional correction of the workpiece and the printing screen.

24. A screen printing machine, comprising:
the imaging system of claim 8;
an image processor for determining a required positional correction of the workpiece and the printing screen from the imaged alignment features; and
a positioner for performing the required positional correction of the workpiece and the printing screen.

25. A screen printing machine, comprising:
the imaging system of claim 9;
an image processor for determining a required positional correction of the workpiece and the printing screen from the imaged alignment features; and
a positioner for performing the required positional correction of the workpiece and the printing screen.

26. A screen printing machine, comprising:
the imaging system of claim 10;
an image processor for determining a required positional correction of the workpiece and the printing screen from the imaged alignment features; and
a positioner for performing the required positional correction of the workpiece and the printing screen.

27. A method of screen printing on workpieces, the method comprising the steps of:
imaging at least one workpiece alignment feature on an upper surface of a supported workpiece and at least one screen alignment feature on the printing screen using the imaging method of claim 19;
determining a required positional correction of the workpiece and the printing screen from the imaged alignment features; and
performing the required positional correction of the workpiece and the printing screen.

28. A method of screen printing on workpieces, the method comprising the steps of:
imaging at least one workpiece alignment feature on an upper surface of a supported workpiece and at least one screen alignment feature on the printing screen using the imaging method of claim 20;
determining a required positional correction of the workpiece and the printing screen from the imaged alignment features; and
performing the required positional correction of the workpiece and the printing screen.

29. A method of screen printing on workpieces, the method comprising the steps of:
imaging at least one workpiece alignment feature on an upper surface of a supported workpiece and at least one screen alignment feature on the printing screen using the imaging method of claim 21;
determining a required positional correction of the workpiece and the printing screen from the imaged alignment features; and
performing the required positional correction of the workpiece and the printing screen.
